(19) United States
(12) Patent Application Publication
(10) Pub. No.: US 2010/0306969 A1
(43) Pub. Date: Dec. 9, 2010

(54) MECHANICAL FASTENER AND METHOD FOR MANUFACTURING A MECHANICAL FASTENER (AS AMENDED)

(75) Inventor: Guntmar Seifert, Plauen (DE)

Correspondence Address: HAMRE, SCHUMANN, MUELLER & LARSON, P.C., P.O. BOX 2902, MINNEAPOLIS, MN, 55402-0902, US

(73) Assignee: WINDHAHER HANDELSGESELLSCHAFT M.B.H., THALGAU (AT)

(21) Appl. No.: 12/745,219

(22) PCT Filed: Nov. 28, 2008
(86) PCT No.: PCT/EP08/10120

§ 371 Date: Aug. 18, 2010

(30) Foreign Application Priority Data
Nov. 29, 2007 (DE) 10 2007 057 905.7

(51) Int. Cl. A44B 18/00; B23P 11/00

(52) U.S. Cl. 24/306; 29/428

(57) ABSTRACT

The invention relates to a sticking closure piece comprising a support (5) and a plurality of hooking means (14) which are monolithically arranged on the support (5). Each hooking means (14) is provided with a stem (15) that is connected to the support (5), and an enlarged top part (13) which is located at the external end of the stem (15). (e) The top part (13) is substantially flat in the region of the face thereof. (f) The edge of the top part (13) has a peripheral projection (16) which points in the direction of the support (5) and the circumferential shape of which is not rotationally symmetrical from a vertical view of the top part (13). (h) The peripheral projection (16) along the circumference of the top part (3) extends in an irregular manner towards the support (5). The invention also relates to a method for producing a sticking closure piece.

The present invention relates to an adhesive fastening component for manufacturing an adhesive fastener, as disclosed in the preamble of claim 1, as well as to a method for manufacturing an adhesive fastening component, as disclosed in the preamble of claim 14.

The adhesive fastening component involves the one component of an adhesive fastening device. The adhesive fastening device is complemented by an additional adhesive fastening component that exhibits a plurality of fibers that are in a non-oriented arrangement and that mesh with the interlocking elements of the first adhesive fastening component and guarantee a connection of the adhesive fastening device. The current trend is to use adhesive fastening components with a lower fiber content for cost reasons. The result is the need to make the complementary adhesive fastening components more effective. One possibility of enhancing the efficiency consists of reducing the size of the interlocking elements in order to enable a larger number of interlocking elements per square centimeter. However, this design renders the molding of the interlocking elements problematic, especially in the case of complex shapes of the same. In addition, too high a number of interlocking elements per unit of area is disadvantageous, because the result is a repelling effect for the opposing adhesive fastening component.

An adhesive fastening component conforming with its genre is already known from EP 1 309 257 B 1. The adhesive fastening component comprises a stem as well as a head piece having a rotationally symmetrical shape in the form of a hyperboloid. Once the adhesive fastening component has been removed from the mold, the head area can be subsequently shaped in a downstream calendering process. The holding effect of the interlocking element is the same along the entire circumference of the head piece in the adhesive fastening component conforming with its genre.

DE 698 27 297 T 2 discloses a method for manufacturing adhesive fastening components with interlocking elements. In this case the interlocking elements are also molded, for example, with cross-shaped stems on a substrate; and in a downstream calendering process the head area of each interlocking element is provided with a roof-shaped shape by means of a counter-mold, which is assigned to each interlocking element and is located in the area of the calendering roll. In so doing, the special hook formation of the interlocking element is achieved in that a special contouring of the outside peripheral edge is achieved by means of the counter-mold. This method is very complex in design in light of the necessity of interlocking elements/assigned counter-molds in the area of the calendering roll.

The object of the present invention is to provide a novel adhesive fastening component of the type conforming with its genre, which guarantees, on the one hand, higher interlocking effectiveness and, on the other, secondly can be manufactured by means of a device that is comparatively simple from a processing point of view.

The present object is achieved by the adhesive fastening component conforming with its genre in that the head piece is configured essentially flattened off in the area of its front side; that the edge side of the head piece exhibits an edge projection, which points in the direction of the substrate; and that the circumferential shape of the edge projection is not rotationally symmetrical when the head piece is viewed from the top; and that the edge projection along the circumference of the head piece extends in an irregular manner towards the substrate. Owing to the irregular distribution of the extension of the edge projection, the interlocking effect is enhanced as a function of the peripheral position. Thus, the fibers obtain additional engagement positions as a function of the peripheral position on the interlocking element—that is, holding positions, which in turn make it possible to achieve improved takeoff values. Since the head piece is designed so as to be essentially flattened off in the area of its front side, it is not necessary to provide a counter-mold, which is assigned individually to the respective head piece and is located in the area of the post-processing roll, for the purpose of forming the head piece. Rather the adhesive fastening component can be subsequently treated with a common roll—for example, a calendering roll or the like. Since at least the head piece—preferably the head piece and the stem—exhibits a non-rotationally symmetrical shape, the result during the after-treatment with heat is a flow property that is not uniformly distributed along the circumference, as a result of which the edge projection extends in an irregular manner towards the substrate.

Preferably the irregular extension of the edge projection towards the substrate along the circumference of the head piece is designed so as to be symmetrical, in particular mirror-symmetrical and/or point-symmetrical, so that, for example, the areas of the edge projections that extend to a greater extent towards the substrate are diametrically opposite. In addition, such a design ensures ease of demolding.

In particular, the areas of the edge projection that extend more towards the substrate can be configured in the shape of a cross in the area of the head piece.

If both the stem and the head piece are designed, when viewed in the cross section, essentially in the shape of a cross, then good demolding properties are guaranteed. In addition, the aforementioned design ensures that the base area of the stem will exhibit a high mechanical strength.

Owing to the after-treatment the transitions between the areas, in which the edge projection extends more towards the substrate, and the areas, in which the edge projection extends less towards the substrate, merge seamlessly with each other.

An additional embodiment of the present invention is characterized in that the head piece is designed in an oblong manner and that the areas of the edge projection, which extend more towards the substrate, are located in the area of the narrow end areas of the head piece. In this way the selected shape of the head piece dictates the special configuration of the edge projection. In addition, the oblong configuration of the fastening component ensures that there exists an oriented takeoff force owing to the identical alignment of the orientation of the individual interlocking elements in relation to the takeoff direction.

Preferably in this case, too, the stem and the head piece are designed, when viewed in the cross section, in an oblong manner. This guarantees especially good demolding properties.

It is especially advantageous for the head piece to exhibit convexly curved sides with end areas that taper to a point. As a result, the head piece has a shape that matches the shape of a longitudinal cut through a lemon. This shape makes possible a distinct interlocking effect in the area of the tips due to the resulting edge projection. Simultaneously the orientation of the head pieces that are shaped in this manner ensures in the manner of a wing effect a preferential direction when the fibers penetrate into the adhesive fastening component. In addition, the above described shape is very easy to demold.

In an alternative embodiment the head piece can also have sides that curve in an undulating manner and that have rounded end areas or end areas that taper to a point. In this case, too, the results are the aforementioned advantages.

Moreover, the head piece can also be designed, for example, in an elliptical or oval manner or have straight sides with rounded end areas or end areas that taper to a point.

According to another embodiment of the present invention, the side areas of the stem are designed in the manner of an arch in the direction of the length of the stem—that is, in such a manner that the side areas of the stem expand towards both the substrate and also towards the head piece. As a result, it is possible to achieve, on the one hand, good strength of the base of the stem on the substrate. On the other hand, the edge areas of the head piece are preshaped outwards, in particular so as to taper to a point outwards, as a result of which in the course of heating the resulting plastic effect or liquefying effect sets in faster and thus improves the formation of the edge projections.

Furthermore, the present invention comprises a method for manufacturing an adhesive fastening component according to the preamble of claim 14. This method is characterized by the use of blind holes having a cross sectional shape that is not rotationally symmetrical, so that during the shaping process a preform of an interlocking element is produced. The stem and/or the head piece of said preform has a cross sectional shape that is not rotationally symmetrical. The preform of the interlocking element is demolded together with the substrate. In a downstream processing step the upper side of the preform at least in the area of the head piece is subjected to a heat treatment so that the flow properties and/or the thermoplastic state change at least in the edge area of the head piece.

The method according to the invention can be carried out without having to have an individual counter-mold for each head piece and, therefore, is comparatively easy to implement in terms of equipment. At the same time it is possible to manufacture the adhesive fastening components with higher efficiency.

The blind holes and/or the entire mold, in which the blind holes are situated, exhibit a layer of nanoparticles. The materials for the nanoparticles are elastomers, polymers, resins, for example, silane resins, or thermoplastic molding compounds. The nanoparticle layer can be made, inter alia, of polytetrafluoroethylene (PTFE). Such a nanoparticle coating has an anti-adhesive effect and, thus, provides a self-cleaning surface.

Preferably a common pressure tool—in particular, a temperature-controlled pressure roll—is used for all of the interlocking elements, which are on the substrate, in the downstream processing step. In this way it is possible to resort to technology that already exists. Moreover, this design makes it also possible to increase the rate of production.

In particular, a heated calendering roll or a roll sonotrode can be provided as the pressure roll.

As an alternative, a so-called air knife can also be used. In this case hot air is applied to the substrate exhibiting the individual interlocking elements.

One practical embodiment of the present invention is explained in detail below with reference to the figures in the drawings. For the sake of a better overview recurring features are provided with just a single reference numeral. In the figures:

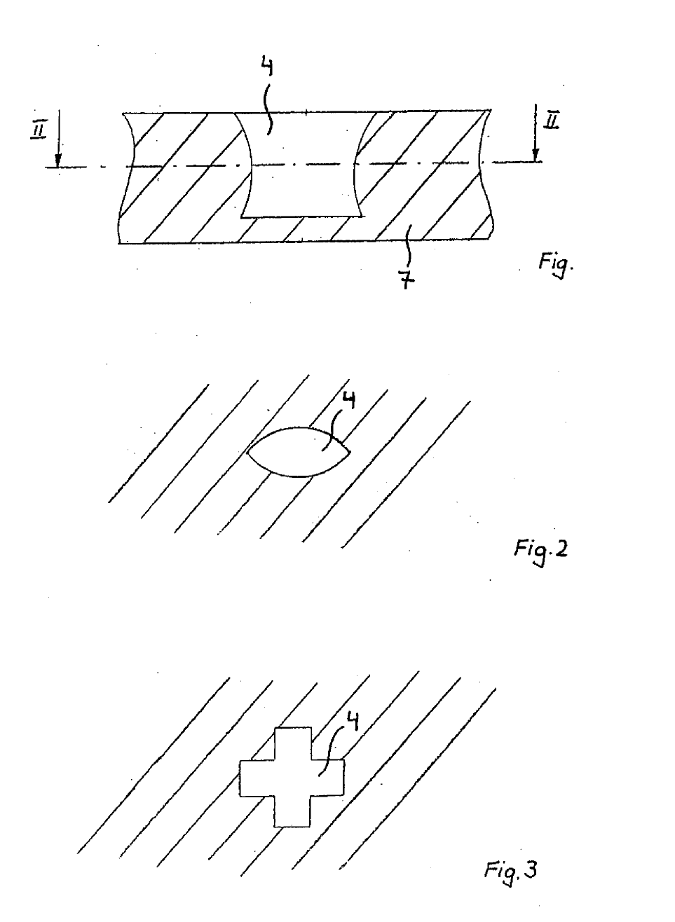

FIG. 1 is a cross sectional view of a blind hole;

FIG. 2 is a top plan view of the blind hole along the intersecting line II-II from FIG. 1 in the shape of a lemon;

FIG. 3 is a top plan view of the blind hole along the intersecting line II-II from FIG. 1 in the shape of a cross;

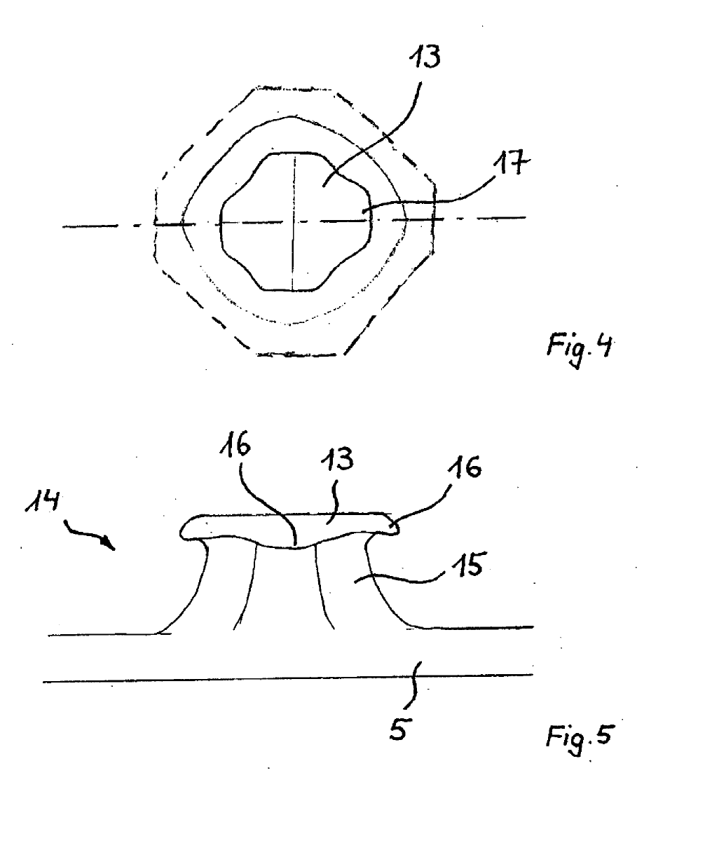

FIG. 4 is a top plan view of a cross-shaped interlocking element;

FIG. 5 is a side view of the interlocking element according to FIG. 4;

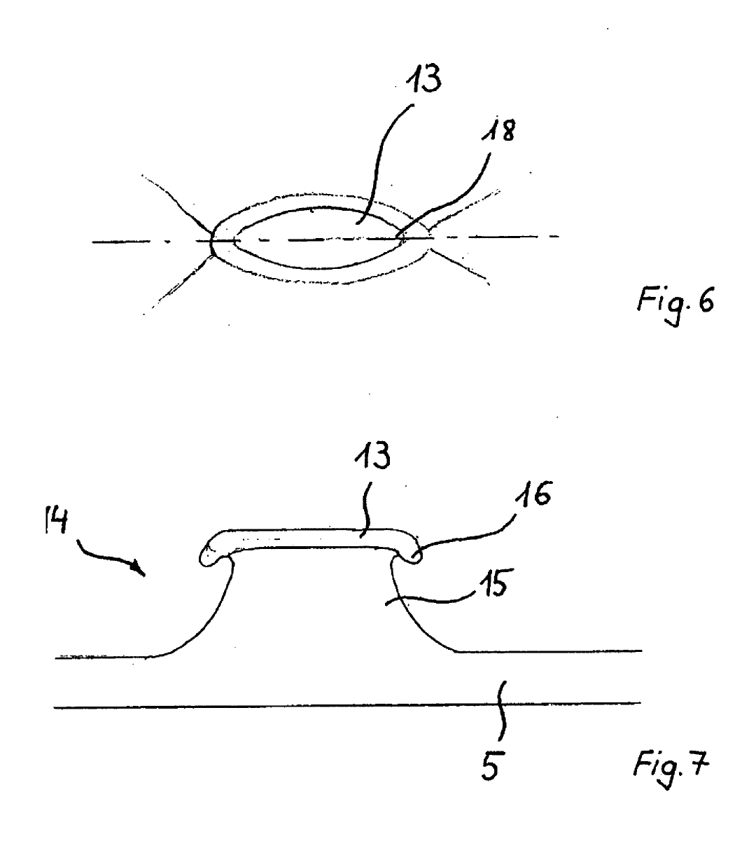

FIG. 6 is a top plan view of a lemon-shaped interlocking element;

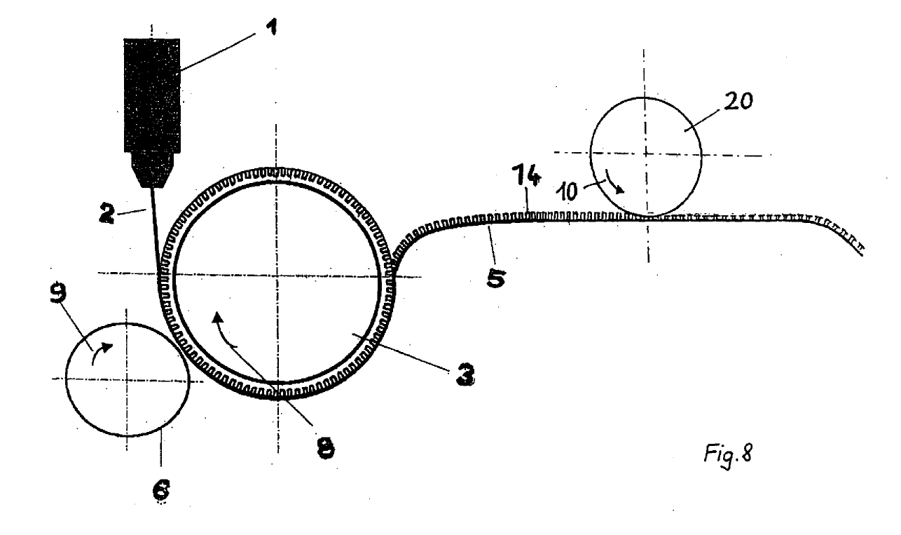

FIG. 7 is a side view of the interlocking element according to FIG. 6, and

FIG. 8 is a schematic drawing of a device for manufacturing adhesive fastening components.

FIGS. 5 and 7 show, in particular, a detail of the adhesive fastening component according to the invention. The adhesive fastening component 21 exhibits a substrate 5 as well as a plurality of interlocking elements 14, which are mounted on the substrate 5 so as to form a single piece, each interlocking element 14 being provided with a stem 15, which is connected to the substrate 5, as well as an enlarged head piece 13, which is located on the outer end of the stem 15. FIGS. 5 and 7 show only one interlocking element 14 each. In this context the head piece 13 is designed so as to be essentially flattened off in the area of the front side of said head piece; and the edge side of the head piece has an edge projection 16, which points in the direction of the substrate 5. The circumferential shape of the edge projection 16 is not rotationally symmetrical when the head piece 13 is viewed from the top (see in particular FIGS. 4 and 6), and the edge projection 16 along the circumference of the head piece 13 extends in an irregular manner towards the substrate 5, a feature that is apparent from FIGS. 5 and 7. Owing to this irregular distribution of the extension of the edge projection 16 the result is a correspondingly higher interlocking effect on the areas, where the edge projection 16 extends more in the direction of the substrate 5. Owing to these especially pronounced overhanging hooks, optimal takeoff values are achieved, since the hooks largely prevent the meshing fibers from sliding off.

As evident from the design variants according to the FIGS. 4 to 7 in the drawings, the irregular extension of the edge projection 16 along the circumference of the head piece 13 is designed mirror-symmetrical towards the substrate 5. As a result, the edge projections 16 lie diametrically opposite. Owing to the symmetry the interlocking elements can be demolded uniformly and easily.

According to a first design variant (FIGS. 4 and 5), the areas of the edge projection 16 that extend more towards the substrate 5 are designed in the manner of a cross in the area of the head piece 13. When viewed in the cross section, the stem 15 and also the head piece 13 are also designed essentially in the shape of a cross. This cross shape makes it possible to achieve hook-like edge projections 16 in four different directions. In addition, the cross shape has the advantage that the stem 15 exhibits a high mechanical strength.

The transitions between the areas, in which the edge projection 16 extends more towards the substrate 5, and the areas, in which the edge projection 16 extends less towards the substrate 5, merge seamlessly with each other. This seamless transition is due to the manufacture of the interlocking element 14. The seamless transition has the advantage that despite the fact that, on the one hand, the edge projections 16 interlock well with the fibers, on the other hand, the interlocking can also be easy to detach again when the two adhesive fastening components are pulled apart, a feature that is just as necessary for an adhesive fastening as it is for a reliable connection.

In a second design variant (see FIGS. 6 and 7) the stem 15 and the head piece 13 are designed in an oblong manner, when viewed in the cross section. In this context the head piece 13 has convexly curved sides with rounded end areas 18 or end areas 18 that taper to a point. The top plan view of the interlocking element 14 and/or its cross sectional shape looks like a lemon in the cross section. This lemon shape has the advantage that the fibers interlock securely in essence in the longitudinal direction (viewed in the cross section) of the interlocking element 14. If a plurality of such oblong interlocking elements 14 are arranged parallel to each other, so that the overall result is a specific texture in the longitudinal direction, then the result is a correspondingly higher takeoff force in the longitudinal direction than in the transverse direction.

Even in the case of the last described design variant, the transitions between the areas, in which the edge projection 16 extends more towards the substrate 5, and the areas, in which the edge projection 16 extends less towards the substrate 5, merge seamlessly with each other.

The side areas of the stems 15 are designed in the manner of an arch in length and expand towards both the substrate 5 and also towards the head piece 13. The blind holes 4 (see FIG. 1), in which the interlocking elements 14 are preformed, already exhibit a matching arch-shaped contouring of the side areas. It is primarily the area that expands towards the head piece 13 that promotes the subsequent shaping of the hook-like edge projections 16.

The inventive method for manufacturing an adhesive fastening component is described below. For this purpose reference is made first to FIG. 8. The adhesive fastening component 21 that is manufactured according to this method is provided with a plurality of interlocking elements 14 that are connected to a substrate 5. In this context each interlocking element 14 has a stem 15, which is connected to the substrate 5. The outer end of the stem 15 has an expanded head piece 13. According to the method, a moldable material is fed into a shape-determining zone between a pressure roll 6 and a mold roll 3. Then they are driven in such a manner that the substrate 5 is formed in the shape-determining zone and conveyed in a conveying direction. In addition, blind holes 4, which are provided on the mold 7, are used. The arrows 8, 9 and 10 show the direction of rotation of each of the rolls.

The method according to the invention uses blind holes 4 that have a cross sectional shape that is not rotationally symmetrical, so that during the shaping process a preform 19 of an interlocking element 14 is produced. The stem 15 and the head piece 13 of said preform have a cross sectional shape that is not rotationally symmetrical. The preform 19 of the interlocking element is demolded together with the substrate 5. In a downstream processing step the upper side of the preform 19 at least in the area of the head piece 13 is subjected to a heat treatment so that the flow properties and/or the thermoplastic state change in the edge area of the head piece 13. A peripheral edge projection 16 that is formed by changing the flow properties and/or the thermoplastic state forms on the head piece 13, which points in the direction of the substrate 5; and the edge projection 16 along the circumference of the head piece 13 extends in an irregular manner towards the substrate 5. This method can be used to manufacture the above-described adhesive fastening components with the advantageous interlocking elements in a comparatively simple and cost effective way.

The downstream processing step uses a heated pressure roll 20 for all of the interlocking elements 14 located on the substrate 5. The pressure roll 20 ensures that at the same time the head area of the preforms 19, which are arranged side by side, is moved into a thermoplastic and/or molten state, as a result of which the preferred edge areas are formed.

### LIST OF REFERENCE NUMERALS

1) flat film die
2) film web
3) mold roll
4) blind hole
5) substrate
6) pressure rolls
7) mold
8) direction of rotation
9) direction of rotation
10) direction of rotation
13) head piece
14) interlocking element
15) stem
16) edge projection
17) area
18) end area
19) preform
20) pressure roll
21) adhesive fastening component

1. Adhesive fastening component comprising
a substrate (5),
a plurality of interlocking elements (14), which are mounted on the substrate (5) so as to form a single piece, each interlocking element (14) exhibiting a stem (15), which is connected to the substrate (5); as well as an enlarged head piece (13), which is located on the outer end of the stem (15),
wherein
(a) the head piece (13) is designed so as to be essentially flattened off in the area of the front side of said head piece,
(b) the edge side of the head piece (13) has an edge projection (16), which points in the direction of the substrate (5),
(c) the circumferential shape of the edge projection (16) is not rotationally symmetrical when the head piece (13) is viewed from the top, and
(d) the edge projection (16) along the circumference of the head piece (13) extends in an irregular manner towards the substrate (5).

2. Adhesive fastening component, as claimed in claim 1,
wherein
the irregular extension of the edge projection (16) towards the substrate (5) along the circumference of the head piece (13) is designed so as to be symmetrical, in particular mirror-symmetrical and/or point-symmetrical.

3. Adhesive fastening component, as claimed in claim 1,
wherein
the areas of the edge projection (16) that extend more towards the substrate (5) are configured in the shape of a cross in the area of the head piece (13).

4. Adhesive fastening component, as claimed in claim 3,
wherein
the stem (15) and the head piece (13) are designed, when viewed in the cross section, essentially in the shape of a cross.

5. Adhesive fastening component, as claimed in claim 4,
wherein
the head piece (13) exhibits four areas (17), of which each one exhibits the edge projection (16) that extends more towards the substrate (5).

6. Adhesive fastening component, as claimed in claim 1,
wherein
the transitions between the areas, in which the edge projection (16) extends more towards the substrate (5), and the areas, in which the edge projection (16) extends less towards the substrate (5), merge seamlessly with each other.

7. Adhesive fastening component, as claimed in claim 1,
wherein
the head piece (13) is designed in an oblong manner and exhibits two narrow end areas (18), and that the areas of the edge projection (16), which extend towards the substrate (5), are located in the area of the narrow end areas (18).

8. Adhesive fastening component, as claimed in claim 7,
wherein
the stem (15) and the head piece (13) are designed in an oblong manner, when viewed in the cross section.

9. Adhesive fastening component, as claimed in claim 7,
wherein
the head piece (13) has convexly curved sides with rounded end areas (18) or end areas (18) that taper to a point.

10. Adhesive fastening component, as claimed in claim 7,
wherein
the head piece (13) has sides that are curved in an undulating manner and that have rounded end areas (18) or end areas (18) that taper to a point.

11. Adhesive fastening component, as claimed in claim 7,
wherein
the head piece (13) is designed in an elliptical or oval manner.

12. Adhesive fastening component, as claimed in claim 7,
wherein
the head piece has straight sides with rounded end areas (18) or end areas (18) that taper to a point.

13. Adhesive fastening component, as claimed in claim 1,
wherein
the side areas of the stem (15) are designed in the manner of an arch in the direction of the length of the stem and expand towards both the substrate (5) and also towards the head piece (13).

14. Method for manufacturing an adhesive fastening component comprising a plurality of interlocking elements (14), which are connected to a substrate (5), each interlocking element (14) having a stem (15), which is connected to the substrate (5); as well as an enlarged head piece (13), which is located on the outer end of the stem (15), in which method a moldable material is fed into a shape-determining zone between a pressure roll (6) and a mold roll (3), which are driven in such a manner that the substrate (5) is formed in the shape-determining zone and conveyed in a conveying direction; and the blind holes (4), which are provided on the mold (7), are used, in particular, for manufacturing an adhesive fastening component, as claimed in any one of the preceding claims,
wherein
a) the use of blind holes (4) that have a cross sectional shape that is not rotationally symmetrical, so that during the shaping process a preform (19) of an interlocking element (14) is produced; the stem (15) and/or the head piece (13) of said preform (19) having a cross sectional shape that is not rotationally symmetrical,
(b) the preform (19) of the interlocking element (14) is demolded together with the substrate (5),
(c) in a downstream processing step the upper side of the preform (19) at least in the area of the head piece (13) is subjected to a heat treatment so that the flow properties and/or the thermoplastic state change at least in the edge area of the head piece (13),
(d) a peripheral edge projection (16) that is formed by changing the flow properties and/or the thermoplastic state forms on the head piece (13), which points in the direction of the substrate (5), and
(e) the edge projection (16) along the circumference of the head piece (13) extends in an irregular manner towards the substrate (5).

15. Method, as claimed in claim 14,
wherein
in the downstream processing step a common pressure tool—in particular, a pressure roll (20)—is used for all of the interlocking elements (14) that are on the substrate (5).

16. Method, as claimed in claim 15,
wherein
a heated calendering roll or a roll sonotrode is provided as the pressure roll (20) for the downstream processing step.

17. Method, as claimed in claim 14,
wherein
an air knife is used in the downstream processing step.
